(19) United States
(12) Patent Application Publication
(10) Pub. No.: US 2023/0148571 A1
(43) Pub. Date: May 18, 2023

(54) POULTRY FEEDER LINE SENSOR TUBE OVERFLOW

(71) Applicant: The GSI Group LLC, Assumption, IL (US)

(72) Inventor: Alan C. Hogan, Assumption, IL (US)

(21) Appl. No.: 17/905,699

(22) PCT Filed: Jun. 29, 2021
(86) PCT No.: PCT/IB2021/055804

§ 371 Date: Sep. 6, 2022

Related U.S. Application Data
(60) Provisional application No. 63/046,170, filed on Jun. 30, 2020.

(51) Int. Cl. A01K 39/012; G01F 23/00

(52) U.S. Cl. CPC A01K 39/012; G01F 23/0007

(57) ABSTRACT

A feeding system for a poultry house used to deliver feed from a bulk feed tank to a plurality of feeding stations. The feeding system includes an overhead feed line supplying a plurality of lateral feed lines spaced along a length of the overhead feed line. Each of the lateral feed lines has a respective feed hopper connected to the overhead feed line. The overhead feed line has a conveyor extending along the length of the overhead feed line with a control unit at an end of the overhead feed line configured to operate the conveyor to move feed to the plurality of hoppers. Each of the plurality of feed hoppers is connected to the overhead feed line with the drop tube. The feed hopper located along the length of the overhead feed line closest to the end of the overhead feed line has an overflow device, the overflow device having a proximal end connected to the drop tube, a feed opening at a distal end through which feed flows into the feed hopper, and at least one additional side opening configured to allow feed to flow out of the overflow device through a path other than through the feed opening if the feed level in the feed hopper reaches a determined level.

### BACKGROUND OF THE INVENTION

### Field of Invention

This disclosure relates to automated poultry feeding systems, and more particularly to a feed overflow device for a poultry feeding system.

### Description of Related Art

In large poultry raising operations, the birds are typically housed in a long poultry house and are fed by a large number of feeding stations that are supplied with feed from a bulk feed tank outside of the poultry house. Horizontal feed tubes are used to distribute to the series of feeding stations. Feed is moved through the feed tubes typically by means of augers. One main supply feed tube may deliver feed to a number of hoppers that in turn supply a number of lateral feed lines. The individual feeding stations are suspended from one of the lateral feed lines by means of a drop tube which is in communication with the feed tube by means of an opening in the feed tube. As feed passes over the opening, the feed will drop through the tube to fill the feeder pan and associated drop tube with feed. As can be appreciated, the hoppers are generally filled sequentially, with the hoppers at the beginning of the main feed supply line being filled first, with the feeding stations also being generally filled sequentially, with the feeding stations at the beginning of the lateral feed line being filled first.

When a hopper runs low on feed, a sensor triggers the auger to begin delivering more feed through the main supply line. One issue that may occur is an overflow near the end of the main supply line may cause feed to back up into the fill line controller area. While the controller area may have a mechanical safety switch to shut off the motor, the controller area needs to be cleared of the packed feed and the system mechanically reset before feed can be delivered again to the hoppers. If the system doesn't get reset promptly, the feed stations may run empty causing the birds to miss a feeding.

### BRIEF SUMMARY OF THE INVENTION

Briefly stated, in one aspect the invention is directed to a feeding system for a poultry house used to deliver feed from a bulk feed tank to a plurality of feeding stations. The feeding system includes an overhead feed line supplying a plurality of lateral feed lines spaced along a length of the overhead feed line. Each of the lateral feed lines has a respective feed hopper connected to the overhead feed line. The overhead feed line has a conveyor extending along the length of the overhead feed line with a control unit at an end of the overhead feed line configured to operate the conveyor to move feed to the plurality of hoppers. Each of the plurality of feed hoppers is connected to the overhead feed line with the drop tube. The feed hopper located along the length of the overhead feed line closest to the end of the overhead feed line has an overflow device, the overflow device having a proximal end connected to the drop tube, a feed opening at a distal end through which feed flows into the feed hopper, and at least one additional side opening configured to allow feed to flow out of the overflow device through a path other than through the feed opening if the feed level in the feed hopper reaches a determined level.

In another aspect of the invention, the distal end of the overflow device is positioned in the feed hopper such that the feed level sensing device is configured so as to send a signal to the control unit while the feed level in the feed hopper is still below a full capacity of the feed hopper such that there is a portion of the feed hopper above a desired full level that is reserved as excess capacity so that when excess feed flowing through a portion of the overhead feed line can escape through the side openings into the overflow portion of the feed hopper.

This summary is provided to introduce concepts in simplified form that are further described below in the Description of Preferred Embodiments. This summary is not intended to identify key features or essential features of the disclosed or claimed subject matter and is not intended to describe each disclosed embodiment or every implementation of the disclosed or claimed subject matter. Specifically, features disclosed herein with respect to one embodiment may be equally applicable to another. Further, this summary is not intended to be used as an aid in determining the scope of the claimed subject matter. Many other novel advantages, features, and relationships will become apparent as this description proceeds. The figures and the description that follow more particularly exemplify illustrative embodiments.

### BRIEF DESCRIPTION OF THE DRAWINGS

The disclosed subject matter will be further explained with reference to the attached figures, wherein like structure or system elements are referred to by like reference numerals throughout the several views.

FIG. 1 is a schematic drawing of a poultry house having a feeding system;

FIG. 2 is a perspective view of a portion of the feeding system of FIG. 1;

FIG. 3 is a side view of a feeder line sensor tube overflow; and

FIG. 4 is an exploded perspective view of the feeder line sensor tube overflow.

Corresponding reference characters indicate corresponding parts throughout the several views of the drawings.

### DESCRIPTION OF PREFERRED EMBODIMENTS

The following detailed description illustrates the invention by way of example and not by way of limitation. This description will clearly enable one skilled in the art to make and use the invention, and describes several embodiments, adaptations, variations, alternatives and uses of the invention, including what we presently believe is the best mode of carrying out the invention. Additionally, it is to be understood that the invention is not limited in its application to the details of construction and the arrangements of components set forth in the following description or illustrated in the drawings. The invention is capable of other embodiments and of being practiced or being carried out in various ways. Also, it is to be understood that the phraseology and terminology used herein is for the purpose of description and should not be regarded as limiting.

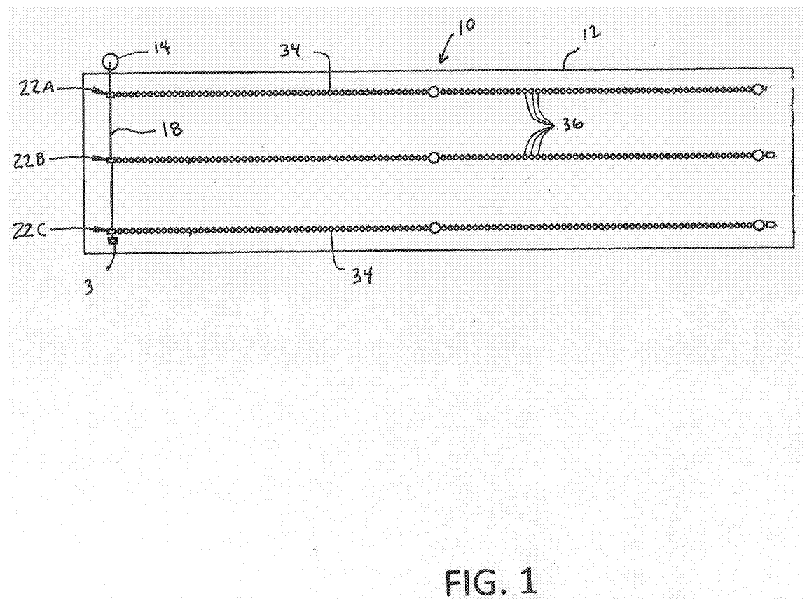

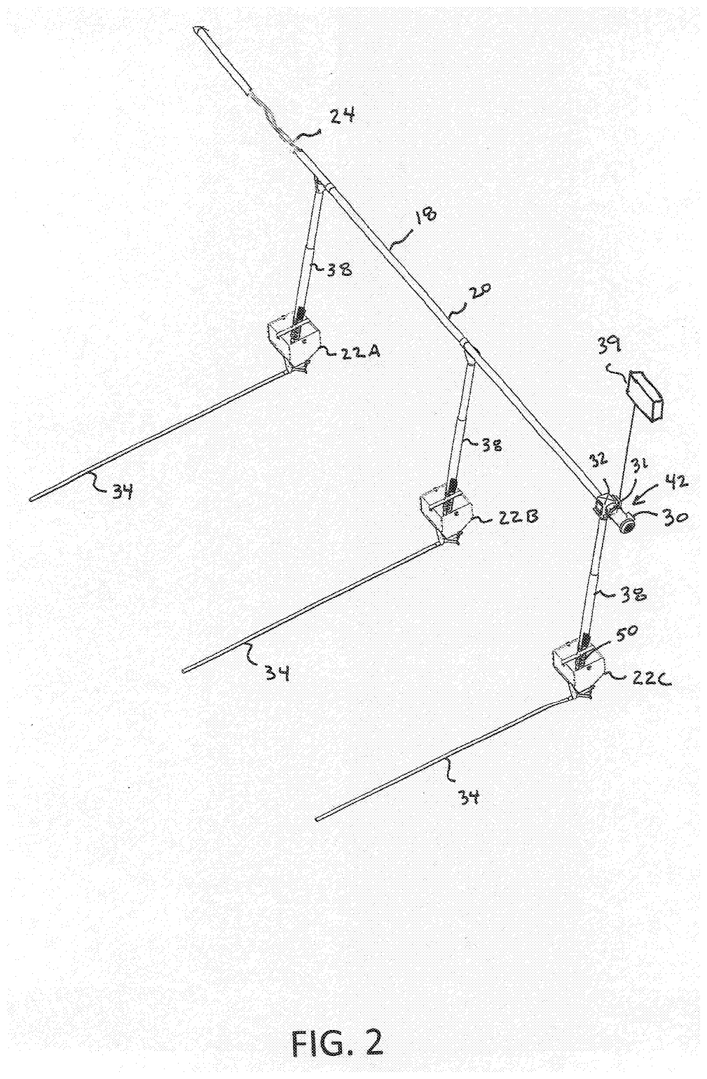

Referring now to the drawings and particularly to FIG. 1, an automated feeding system is indicated at 10. By way of background and as would be understood by one skilled in the art, the automated feeding system 10 is used in a poultry house 12 to deliver feed that is typically stored in a bulk feed tank 14 located outside of the poultry house 12 in a manner well known to those skilled in the art. Typically, such poultry houses 12 are long structures having a length of several hundred feet and a width of about 40-60 feet. For example, a typical poultry house 12 may have a length of about 300 feet and house about 15,000-20,000 birds. The automated feeding system 10 has at least one overhead feed line 18 which typically runs the length of one direction of the poultry house 12. Turning also now to FIG. 2, the overhead feed line 18 comprises a rigid conveyor tube 20 that extends a relatively long distance within the poultry house. The feed conveyor tube 20 has a plurality of bottom-facing openings that direct feed to a plurality of feed hoppers 22 spaced along the length of the feed conveyor tube 20 so that feed conveyed by the overhead feed line 18 may be delivered to each of the feed hoppers 22. In the illustrated example, three feed hoppers (22A, 22B and 22C) are shown, however, the automated feeding system 10 will likely have many more feed hoppers 22 spaced along each of the overhead feed lines 18.

As would be understood by one skilled in the art, a conveyor 24 extends along the length of the overhead feed line 18 in the conveyor tube 20. In one embodiment the conveyor 24 is an auger conveyor rotatably driven by an electric motor 30 and suitable gearbox 31 located in a control unit 32 where the conveyor 24 is connected to the gear box 31. Alternatively, it will be understood that other types of feed conveying mechanisms, other than an auger can be used to deliver feed through the feed conveyor tube 20 such as a so-called centerless or flexible auger, such as shown in the prior art U.S. Pat. No. 5,875,882, or other such conveying means.

A lateral feed line 34 extends from each of the feed hoppers 22. Each of the lateral feed lines 34 has a multiplicity of feeding stations 36 spaced therealong at substantially equal intervals (e.g., about 2.5 foot intervals). As feed is delivered through the conveyor tube 20, as noted above, the feed drops through a drop tube 38 to the specific hopper 22 under gravity. Feed from each feed hopper 22 is then used to supply the lateral feed lines 34, which in turn supplies the feeding stations 36. As the birds in the poultry house consume the feed in the feeding stations 36. As the feeding stations 36 may be of any known design, they will not be described in further detail herein. The automated feeding system 10 is typically suspended from the ceiling or roof of the poultry house 12 by means of a well-known winch and cable assembly (shown schematically at 39) that may be selectively operated to raise or lower the overhead feed line 18 and all of the feeding stations 36 connected thereto.

As best seen in FIG. 2 each feed hopper 22 is connected to the conveyor tube 20 of the overhead feed line 18 with the drop tube 38. The drop tube 38 closest to the end of the overhead feed line 18 extends downward from near the control unit 32. In one embodiment, the control unit 32 has relays (not shown) to connect to the motor 30 and a capacitance or mechanical pressure switch (not shown) that detects whether the control unit 32 is full of feed to act as a backup safety. If feed backs up all the way to this control unit 32, it will shut of the motor 30 so that feed doesn't destroy the system 12. If enough feed gets to the point where the safety switch is triggered, the feed likely has become packed in because it had no outlet. This will leave residue in the control unit 32 that will need to be manually cleaned.

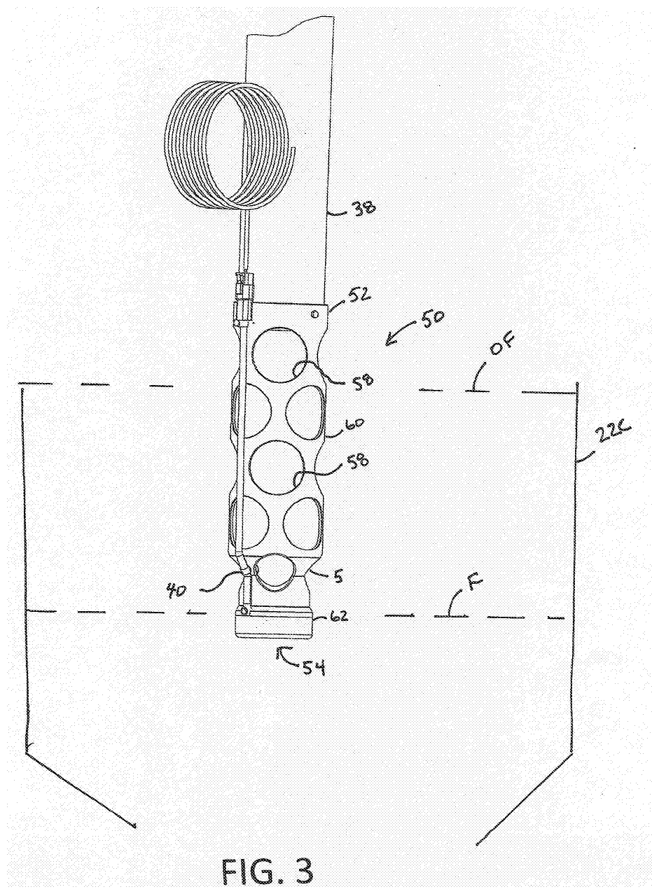

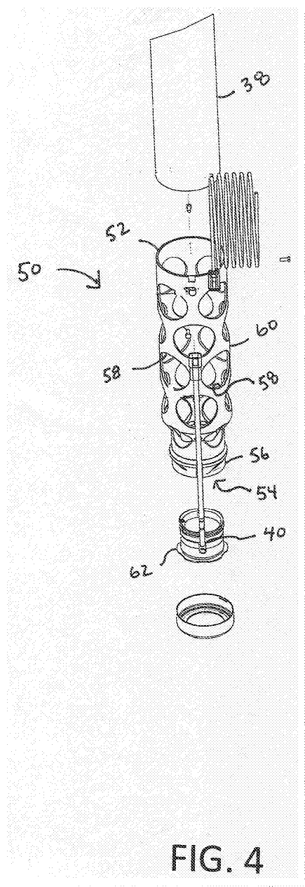

Turning now to FIGS. 3 and 4, the level of feed in the hoppers 22 is desirably monitored with a feed level sensing device 40 that uses infrared (IR) sensors such as the system disclosed in commonly assigned U.S. Pat. No. 9,247,718 entitled Poultry Feeder with Level Sensor. However, one skilled in the art will understand that other feed level sensing systems using mechanical or other sensors may be used using sound engineering judgment with departing from the scope of the invention. Because feed level sensing devices 40 are known in the art, such a device need not be discussed in further detail herein.

When the feed level sensing device 40 senses that the level of feel in its associated hopper 22 has dropped below a desired level, the feed level sensing device 40 sends a signal to the control unit 32 (FIG. 2), which activates the motor 30 (FIG. 2) to cause feed to be delivered through the conveyor 24 to the hoppers 22. Hence, the motor 30 for the auger (or other conveying mechanism) 24 will not be activated until the feed level sensing device 40 determines that the feed in the hopper 22 has fallen below a predetermined level.

According to the invention, at least the feed hopper 22C closest to a downstream end 42 of the overhead feed line 18 is connected to its drop tube 38 with an overflow device 50. In one embodiment, the overflow device 50 is a device connected to the drop tube 38 at a proximal end 52 and with a normal-flow feed opening 54 at a distal end 56 through which feed flows into the feed hopper 22C. The overflow device 50 has at least one additional side opening 58 configured to allow feed to flow out of the overflow device 50 through a path other than through the feed opening 54 in the distal end 56. In the illustrated embodiment, the overflow device 50 comprises a cylindrical tube 60 with a plurality of side openings 58 that allow feed to flow out of the cylindrical tube 60 but such that the feed flowing out of the side openings 58 still falls into the hopper 22C. The cylindrical tube 60 receives a sensor mounting ring 62 configured to mount the feed level sensing device 40. The distal end 56 of the overflow device 50 is positioned in the feed hopper 22C such that the feed level sensing device 40 is configured so as to send a signal to stop the motor 30 while the feed level in the feed hopper 22C is still below a full capacity of the feed hopper 22C. Thus, there is a portion of the feed hopper 22C above a desired full level (F) that is reserved as excess capacity. If another feed hopper (22A or 22B) signals that feed is required even when a portion 64 of the conveyor tube 20 leading to the drop tube 38 of feed hopper 22C is full of feed and feed hopper 22C is at or reaches its desired full level(F), excess feed flowing through the portion 64 of the conveyor tube 20 can escape through the side openings 58 into the overflow portion (OF) of the feed hopper 22C, therefore desirably preventing feed from compacting around the control unit and gearbox 31 and motor 30 of the conveyor 20.

While the automated feeding system 10 of the present disclosure has been described to be a broiler feeding system 10 intended for use in raising broiler chickens, it will be apparent to those skilled in the art that the automated feeding system 10 described herein may be used with all types of poultry, including other livestock, such as ducks and turkeys. As various changes could be made in the above constructions without departing from the broad scope of the invention, it is intended that all matter contained in the above description or shown in the accompanying drawings shall be interpreted as illustrative and not in a limiting sense.

1. A feeding system for a poultry house used to deliver feed from a bulk feed tank to a plurality of feeding stations, the feeding system comprising an overhead feed line supplying a plurality of lateral feed lines spaced along a length of the overhead feed line, each of the lateral feed lines having a respective feed hopper connected to the overhead feed line, the overhead feed line having a conveyor extending along the length of the overhead feed line with a control unit at an end of the overhead feed line configured to operate the conveyor to move feed to the plurality of hoppers, wherein each of the plurality of feed hoppers is connected to the overhead feed line with the drop tube, the feed hopper located along the length of the overhead feed line closest to the end of the overhead feed line comprises an overflow device, the overflow device having a proximal end connected to the respective drop tube, a feed opening at a distal end through which feed flows into the feed hopper, and at least one additional side opening configured to allow feed to flow out of the overflow device through a path other than through the feed opening if the feed level in the feed hopper reaches a determined level.

2. The feeding system of claim 1 wherein each of the plurality of feed hoppers has a feed level sensing device configured to monitor a level of feed in the feed hopper, and when the feed level sensing device senses that the level of feel in its associated feed hopper has dropped below a desired level, the feed level sensing device sends a signal to the control unit to cause feed to be delivered by the conveyor to the hopper.

3. The feeding system of claim 2 wherein the overflow device comprises a cylindrical tube with a plurality of side openings that allow feed to flow out of the cylindrical tube but such that the feed flowing out of the side openings still falls into the hopper.

4. The feeding system of claim 3 wherein the overflow device has a sensor mounting ring configured to mount the feed level sensing device.

5. The feeding system of claim 4 wherein the distal end of the overflow device is positioned in the feed hopper such that the feed level sensing device is configured so as to send a signal to the control unit while the feed level in the feed hopper is still below a full capacity of the feed hopper such that there is a portion of the feed hopper above a desired full level that is reserved as excess capacity so that when excess feed flowing through a portion of the overhead feed line can escape through the side openings into the overflow portion of the feed hopper.
